(19) United States
(12) Patent Application Publication
(10) Pub. No.: US 2026/0320709 A1
(43) Pub. Date: Oct. 15, 2026

(54) ORDER RECEPTION MANAGEMENT DEVICE AND ORDER RECEPTION MANAGEMENT SYSTEM

(71) Applicant: SEIKO EPSON CORPORATION, Tokyo (JP)

(72) Inventors: Takuto TANAKA, SHIOJIRI-SHI (JP); Yusuke KOMIYAMA, MATSUMOTO-SHI (JP); Ayako TANABE, MATSUMOTO-SHI (JP); Asuka SUGIHARA, SHIOJIRI-SHI (JP); Tetsuji YATSUNAMI, OKAYA-SHI (JP); Yuji MISAWA, MATSUMOTO-SHI (JP); Masaki SHIMOMURA, MATSUMOTO-SHI (JP); Kazuhisa KAWAKAMI, MATSUMOTO-SHI (JP)

(21) Appl. No.: 19/642,213

(22) Filed: Apr. 8, 2026

(30) Foreign Application Priority Data
Apr. 9, 2025 (JP) 2025-064089

(51) Int. Cl. G06Q 50/12

(52) U.S. Cl. CPC G06Q 50/12

(57) ABSTRACT

An order reception management device includes an order data reception section configured to receive order data including information related to an order of a customer; an order reception process section configured to process the order data received by the order data reception section to generate process data; and a process data transmission section that sends the process data to an output unit that visually outputs content of the order according to the process data, wherein the order reception process section includes, in the process data, content of the order and a symbol that varies depending on a time related to the order.

### CROSS REFERENCE TO THE RELATED APPLICATION

The present application is based on, and claims priority from JP Application Serial Number 2025-064089, filed Apr. 9, 2025, the disclosure of which is hereby incorporated by reference herein in its entirety.

### BACKGROUND

### 1. Technical Field

The present disclosure relates to an order reception management device and an order reception management system that manages orders of customers.

### 2. Related Art

The order support system disclosed in JP-A 2024-012715 receives orders of food and drink for each table of a restaurant that provides food and drink, and calculates a serving time difference between a plurality of ordered food and drink to be provided for each table. The order support system determines, with respect to both the food and drink included in a first order corresponding to a first table and also the food and drink included in a second order corresponding to a second table, whether the serving time difference corresponding to each of the first table and the second table in a case of cooking is within a set time. When the serving time difference corresponding to each of the first table and the second table is within the set time, order information including the first order and the second order is output.

That is, even when the food and drink of the first order and the food and drink of the second order are cooked together, if both the food and drink of the first order and the food and drink of the second order can be provided within the set time, the order supporting system outputs the first order and the second order to the kitchen terminal together. This minimizes the difference in timing of serving the food among a plurality of users using tables, and improves the work efficiency of the kitchen.

The order support system described in JP-A-2024-012715 has room for improvement in that it is difficult for the kitchen staff to grasp the food or drink when serving is delayed.

### SUMMARY

An order reception management device according to the present disclosure for solving the above problem includes an order data reception section configured to receive order data including information related to an order of a customer; an order reception process section configured to process the order data received by the order data reception section to generate process data; and a process data transmission section that sends the process data to an output unit that visually outputs content of the order according to the process data, wherein the order reception process section includes, in the process data, content of the order and a symbol that varies depending on a time related to the order.

An order reception management system according to the present disclosure includes the above order reception management device and the above output unit.

An order reception management system according to the present disclosure is an order reception management system that includes the above order reception management device and the above output unit, wherein the symbol is a first symbol, when, within a predetermined time after order data related to a first order is received, order data is received related to a second order including a product or service that is the same as a product or service included in the first order, then the order reception process section includes, in the process data, a second symbol that is different from the first symbol and indicates that the same product or service has been ordered, the order reception process section includes, in the process data, a number of products or services that are the same, and the output unit is constituted by a display device for displaying the content of the order and the symbol on a screen.

An order reception management system according to the present disclosure includes the above order reception management device; a transmission section that generates the order data according to an order of a customer and transmits the order data to the order reception management device; and the output unit.

### BRIEF DESCRIPTION OF THE DRAWINGS

FIG. 1 is a diagram illustrating an overall configuration of an order reception management system.

FIG. 2 is a block diagram illustrating the configuration of an order management server.

FIG. 3 is a block diagram illustrating a configuration of a user order terminal.

FIG. 4A is a diagram illustrating an example of a UI displayed on a user order terminal.

FIG. 4B is a diagram illustrating an example of a UI displayed on a user order terminal.

FIG. 5 is a diagram illustrating the contents of received order data.

FIG. 6A is a diagram illustrating an order slip printed by the printing device.

FIG. 6B is a diagram illustrating an order slip printed by the printing device.

FIG. 7 is a diagram illustrating a first symbol set for each time period.

FIG. 8 is a flowchart illustrating a flow of processes in an order reception process section.

FIG. 9 is a diagram illustrating overall configuration of an order reception management system according to another embodiment.

FIG. 10 is a block diagram illustrating configuration of a display device.

FIG. 11 is a diagram illustrating contents of received order data.

FIG. 12 is a diagram illustrating order content displayed by the display device.

FIG. 13 is a flowchart illustrating a flow of processes in an order reception process section.

### DESCRIPTION OF EMBODIMENTS

The present disclosure will be schematically described below.

The order reception management device according to a first aspect includes an order data reception section configured to receive order data including information related to an order of a customer; an order reception process section configured to process the order data received by the order data reception section to generate process data; and a process data transmission section that sends the process data to an output unit that visually outputs content of the order according to the process data, wherein the order reception process section includes, in the process data, content of the order and a symbol that varies depending on a time related to the order.

According to this aspect, the order reception process section includes, in the process data, the content of the order and the symbol that varies depending on the time related to the order. As a result, the person in charge of taking orders can visually recognize the symbol that varies depending on the time related to the order in addition to the content of the order. For example, when the output unit outputs only the time in addition to the content of the order, it may be difficult for the person in charge of taking orders to visually grasp the time. However, according to the present aspect, the person in charge of taking orders can easily visually grasp the time by the symbol. By this, the person in charge of taking orders can appropriately process the orders such as preferentially processing an order whose process is late.

A second aspect is an aspect according to the first aspect, wherein the order reception process section includes, in the process data, a time related to the order.

According to this aspect, since the order reception process section includes the time related to the order in the process data, the person in charge of taking orders can accurately grasp the time related to the order as necessary.

A third aspect is an aspect according to the first aspect, wherein the order reception process section generates the process data so that the output unit outputs the different symbols in different colors.

According to this aspect, the order reception process section generates the process data so that the output unit outputs the different symbols in different colors, so the person in charge of taking orders can more easily visually grasp the time.

It should be noted that this aspect is not limited to the first aspect, and may be according to the second aspect.

A fourth aspect is an aspect according to the first aspect, wherein the symbol is a first symbol and when, within a predetermined time after order data related to a first order is received, order data is received related to a second order including a product or service that is the same as a product or service included in the first order, then the order reception process section includes, in the process data, a second symbol that is different from the first symbol and that indicates that the same product or service has been ordered.

When orders for the same product or service are generated, it is efficient for the person in charge of taking orders to process the orders together. According to this aspect, the person in charge of taking orders can visually recognize the second symbol indicating that the same product or service has been ordered, in addition to the content of the order and the first symbol. By this, the person in charge of taking orders can collectively process the same commodities or services, and the efficiency of order process can be improved.

It should be noted that this aspect is not limited to the first aspect, and may be according to the second or third aspect.

A fifth aspect is an aspect according to the fourth aspect, wherein the order reception process section includes, in the process data, a number of products or services that are the same.

According to this aspect, the person in charge of taking orders can grasp the number of orders together with the second symbol indicating that the same product or service has been ordered, and thus it is possible to further improve the efficiency of the order process.

A sixth aspect is an aspect according to the fourth aspect, wherein the order reception process section generates the process data so as to arrange the content of the order between the first symbol and the second symbol.

If the first symbol and the second symbol are arranged at positions close to each other, the person in charge of taking orders may erroneously recognize the two symbols as the first symbol together.

According to this aspect, the order reception process section generates the process data so as to arrange the content of the order between the first symbol and the second symbol, and thus it is possible to suppress the occurrence of the above-described problem.

It should be noted that this aspect is not limited to the fourth aspect, and may be according to the fifth aspect.

A seventh aspect is an aspect according to the fourth aspect, wherein the predetermined time is set for each product or service.

According to this aspect, since the predetermined time is set for each product or service, it is possible to perform an appropriate process according to the product or service.

It should be noted that this aspect is not limited to the fourth aspect, and may be according to the fifth or sixth aspect.

An eighth aspect is an aspect according to the fourth aspect, wherein the order reception process section generates the process data so that the first symbol related to the second order is the same as the first symbol related to the first order.

When an order for a product or service is generated and order processes for a plurality of products or services is performed collectively, if processing of the first order, which is the earliest order, is delayed, there is a risk that the person who ordered it will be dissatisfied.

According to this aspect, the order reception process section generates the process data so that the first symbol related to the second order is the same as the first symbol related to the first order, and thus it is possible to suppress a delay in the process of the first order.

It should be noted that this aspect is not limited to the fourth aspect, and may be according to any one of the fifth to seventh aspects.

An order reception management system according to a ninth aspect includes the order reception management device according to any one of the first to eighth aspects, and the output unit.

According to this aspect, in the order reception management system including the order reception management device according to any one of the first to eighth aspects and the output unit, the operational effects of any one of the first to eighth aspects described above are obtained.

A tenth aspect is an aspect according to the ninth aspect, wherein the output unit is constituted by a printing device for printing the content of the order and the symbol on a medium.

According to this aspect, the output unit is configured by a printing device that prints the content of the order and the symbol on a medium, and thus the person in charge of taking orders can easily visually recognize the content of the order and the symbol.

An eleventh aspect is an aspect according to the ninth aspect, wherein the output unit is constituted by a display device for displaying the content of the order and the symbol on a screen.

According to this aspect, the output unit is configured by a display device that displays the content of the order and the symbol on a screen, and thus the person in charge of taking orders can easily visually recognize the content of the order and the symbol. In addition, the information related to the order can be easily updated to the latest information.

It should be noted that this aspect is not limited to the ninth aspect, and may be according to the tenth aspect.

An order reception management system according to a twelfth aspect is an aspect depending on the fifth aspect, and is an order reception management system that includes the output unit, wherein the output unit is constituted by a display device for displaying the content of the order and the symbol on a screen.

According to this aspect, the output unit is configured by a display device that displays the content of the order and the symbol on a screen, and thus the person in charge of taking orders can easily visually recognize the content of the order and the symbol. The information relating to the order can be easily updated to the latest information, and particularly, the number of the same products or services can be easily updated to the latest number.

An order reception management system according to a thirteenth aspect includes the order reception management device according to any one of the first to eighth aspects; a transmission section that generates the order data according to an order of a customer and transmits the order data to the order reception management device; and the output unit.

According to this aspect, in the order reception management system including the order reception management device according to any one of the first to eighth aspects, the transmission section that generates the order data according to the order of the customer and transmits the order data to the order reception management device, and the output unit, the operational effect of any one of the first to eighth aspects described above is obtained.

Hereinafter, the present disclosure will be described in detail.

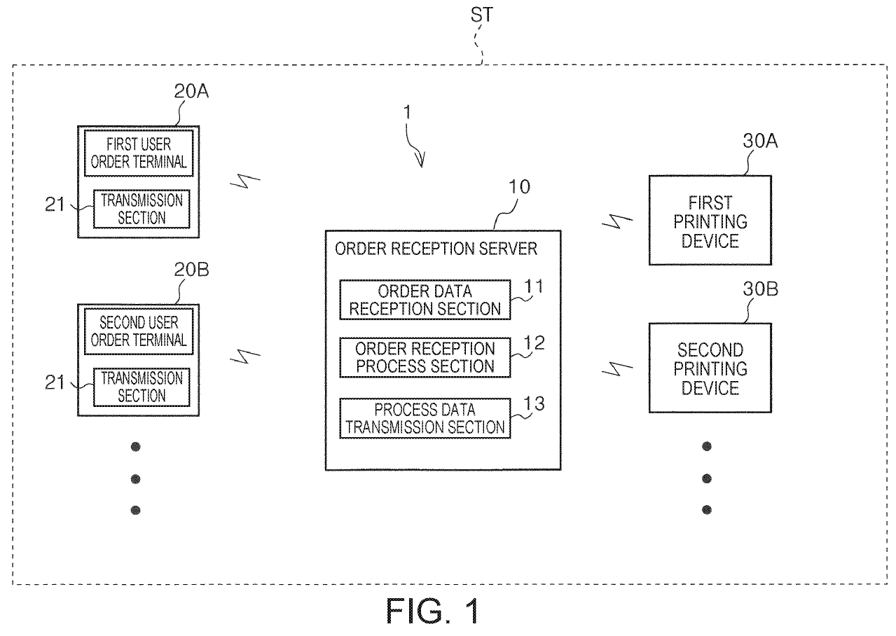

In FIG. 1, reference sign ST denotes a store, and the store ST includes an order reception management system 1. It should be noted that in the embodiment described below, the store ST is assumed to be a shop of a eat-in type that provides food and drink to customers, but the order reception management system 1 is not applicable only to such a store ST. Food and drink are examples of products, but the products are not limited to food and drink. The order handled by the order reception management system according to the present disclosure is not limited to a product, and may include a service.

In this embodiment, the order reception management system 1 includes an order reception server 10, a first user order terminal 20A, a second user order terminal 20B, a first printing device 30A, and a second printing device 30B.

Hereinafter, the first user order terminal 20A and the second user order terminal 20B are collectively referred to as a user order terminal 20 when they are not distinguished from each other. Although two user order terminals 20 are illustrated in FIG. 1, the number of user order terminals 20 is not limited to this.

In a case where the first printing device 30A and the second printing device 30B are not distinguished from each other, they are collectively referred to as a printing device 30. Although two printing devices 30 are illustrated in FIG. 1, the number of printing device 3030 is not limited to this.

The user order terminal 20 is a terminal operated by a customer, and is a terminal arranged on a table used by the customer when eating and drinking. The user order terminal 20 is a touch panel type information terminal. The customer uses the user order terminal 20 to select a menu and place an order. The user order terminal 20 has a transmission section 21, which is a functional part for transmitting order data, which includes information related to the order of the customer, to the order reception server 10.

The order reception server 10 is disposed, for example, in the backyard of the store ST. The order reception server 10 is a computer device capable of communicating with the user order terminal 20. The order reception server 10 includes an order data reception section 11, an order reception process section 12, and a process data transmission section 13. The order data reception section 11 receives order data, which includes information related to an order of a customer, from the user order terminal 20. The order reception process section 12 processes the order data received by the order data reception section 11 to generate process data. The process data transmission section 13 sends the process data to a printing device 30, which is an example of an output unit that visually outputs the content of the order according to the process data. When the output unit is the printing device 30, the process data is print data.

The functional sections described above are sections focusing on the functions of the order reception server 10, and are realized by the order reception server 10 executing a program. Therefore, the functional sections are not necessarily implemented by separate programs, and a plurality of or all the functional sections may be implemented by one program.

The printing device 30 is a printing device that performs printing on a medium based on the print data transmitted from the order reception server 10, and is disposed in, for example, the kitchen of the store ST. The printing device 30 is, for example, a thermal printer having a thermal head (not illustrated), and has a function of printing on roll paper, which is thermal paper, and a cutting function of cutting the roll paper. The detailed structure of the printing device 30 is not illustrated in the drawings and will not be described. It should be noted that the printing device 30 is not limited to a thermal printer and may be a printer of another type such as an ink jet printer that performs printing by ejecting ink.

The printing device 30 is capable of communicating with the order reception server 10 and performs printing in accordance with print data transmitted from the order reception server 10.

The staff of the store ST includes kitchen staff who cook in a kitchen, serving staff who serve tables in the dining area, and the like, and these are collectively referred to as store staff hereinafter. The store staff is an example of a person in charge of taking orders, and cooking, serving, and the like performed by the store staff are examples of processing an order. Among the store staff, the kitchen staff prepares food and drink such as dishes and drinks based on an order slip (to be described later) printed by the printing device 30.

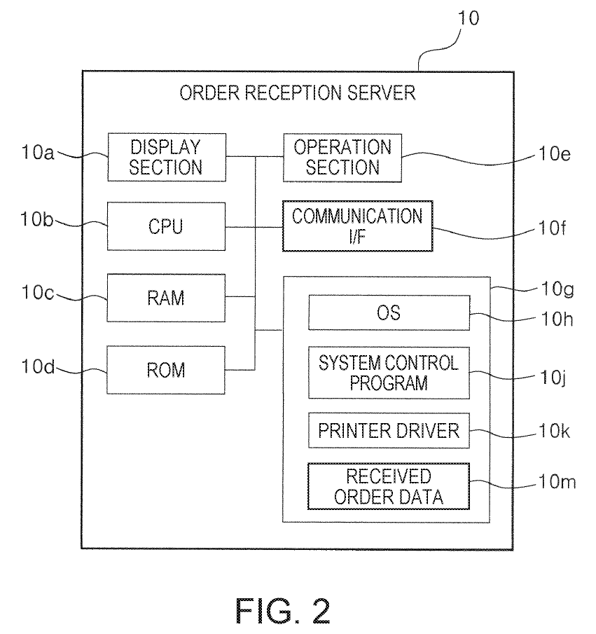

The configuration of the order reception server 10 will be described below with reference to FIG. 2.

The order reception server 10 includes an operation section 10e, a display section 10a, a CPU 10b, a RAM 10c, a ROM 10d, a communication interface 10f, and storage 10g. It should be noted that in the drawings and the following description, the term "interface" is expressed as "I/F ".

The storage 10g is configured by an information storage device such as a hard disk drive (HDD) or a solid-state drive (SSD). The storage 10g stores various types of data and various programs such as an operating system 10h, a system control program 10j, a printer driver 10k, and received order data 10m. It should be noted that in the drawings and the following description, the term "operating system" is expressed as "OS".

The system control program 10j is a program that controls the entire order reception management system 1 and, unless otherwise specified, various processes performed by the order reception server 10 described below are realized by executing the system control program 10j. In particular, the functions of the order data reception section 11, the order reception process section 12, and the process data transmission section 13 are realized by the CPU 10b executing the system control program 10j.

The printer driver 10k is used for printing using the printing device 30. When printing is performed using the printing device 30, the OS 10h activates the printer driver 10k, and the printer driver 10k generates print data for printing an order slip (to be described later).

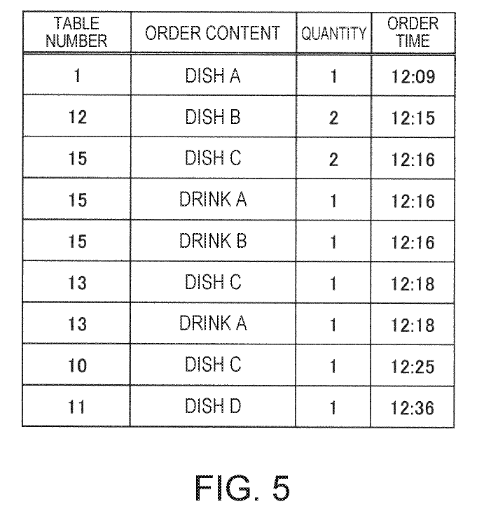

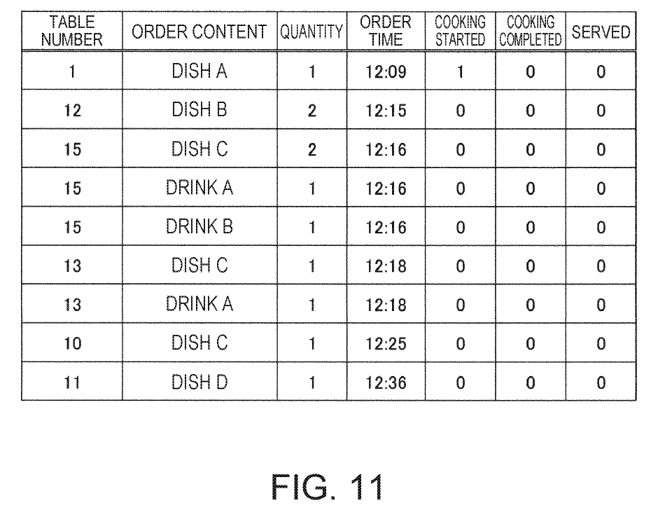

The received order data 10m includes various information related to customer orders. The various information related to customer orders will be described later with reference to FIG. 5 or FIG. 11.

The CPU 10b loads various programs and the like stored in the ROM 10d or the storage 10g into the RAM 10c, which is a volatile memory, and executes the programs.

The operation section 10e is constituted by a keyboard (not illustrated) and a pointing device such as a mouse or a touch pad.

The display section 10a is configured by a liquid-crystal display or the like.

The communication I/F 10f includes a communication interface for connecting the order reception server 10 to the Internet, and an interface for communicating with the user order terminals 20 and the printing devices 30.

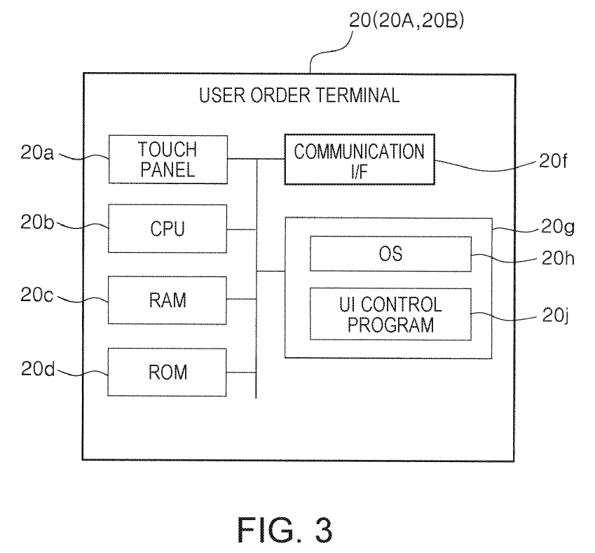

Hereinafter, a configuration of the user order terminal 20 will be described with reference to FIG. 3.

The user order terminal 20 includes a touch panel 20a, CPU 20b, RAM 20c, ROM 20d, communication I/F 20f, and storage 20g.

The storage 20g is configured by an information storage device such as a flash memory. The storage 20g stores various data and various programs such as an operating system 20h and a UI control program 20j.

The UI control program 20j is a program for controlling the display of the touch panel 20a, in particular, the display of the user interface, and unless otherwise specified, various processes performed by the user order terminal 20 described below are realized by executing the UI control program 20j. The function of the transmission section 21 (see FIG. 1) that transmits order data including information related to customer orders to the order reception server 10 is also realized by executing the UI control program 20j. It should be noted that in the present specification and the drawings, the term "user interface" is denoted as "UI ".

The CPU 20b loads various programs and the like stored in the ROM 20d or the storage 20g into the RAM 20c, which is a volatile memory, and executes the programs.

The touch panel 20a displays various types of information and receives various operations by a user.

The communication I/F 20f includes a communication interface for connecting the user order terminals 20 to the order reception server 10.

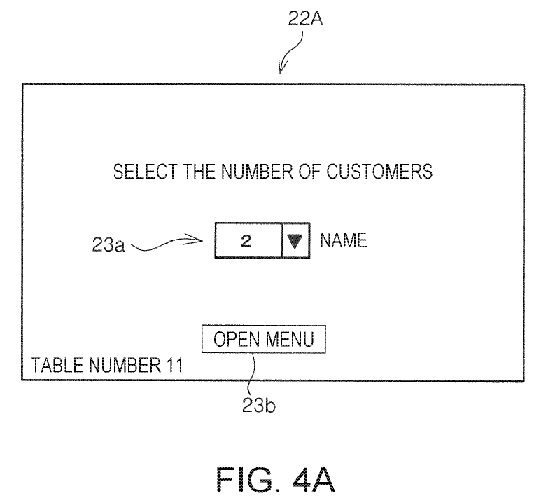

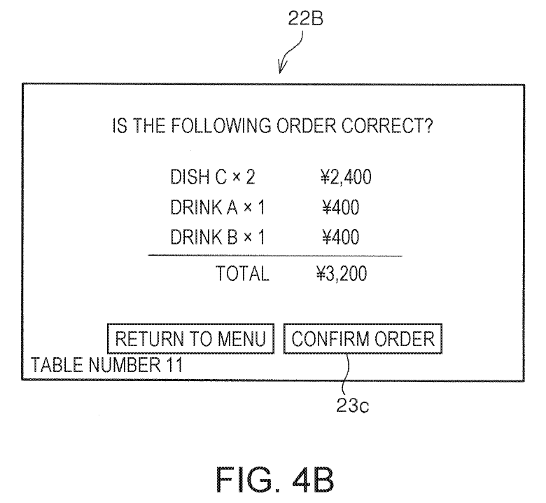

A UI 22A illustrated in FIG. 4A is a UI displayed on the user order terminals 20 and is a UI displayed first when the customer places an order. In the UI 22A, a drop down list 23a for inputting a number of people is displayed. When the customer sets the number of people via the drop-down list 23a and taps an "open menu" button 23b, the screen transitions to a menu screen (not illustrated).

A UI 22B illustrated in FIG. 4B is a UI displayed on the user order terminals 20, and illustrates an example of a UI when the customer confirms the order. The UI 22B displays a list of order contents. When the customer taps a “confirm order" button 23c, the user order terminal 20 generates order data including the order content and transmits the order data to the order reception server 10 using the function of the transmission section 21.

When the order reception process section 12 of the order reception server 10 receives the order data via the order data reception section 11, the order reception process section 12 adds the new order data to the received order data 10m.

FIG. 5 illustrates an example of information included in the received order data 10m. The received order data 10m includes information about the table number, the order content, the quantity, and the order time. The table number is a number associated with the table of the customer and is included in the order data transmitted from the user order terminal 20. The order time is the time when the “confirm order" button 23c illustrated in FIG. 4B is tapped, the order content and quantity are the order content and quantity at that time, and these are included in the order data transmitted from the user order terminal 20. The order time is an example of a time related to the order and is not necessarily limited to the time when the "confirm order" button 23c is tapped.

When the order reception process section 12 of the order reception server 10 receives the order data and updates the received order data 10m, the order reception process section 12 generates print data based on the order data. Then, the process data transmission section 13 of the order reception server 10 transmits the print data to the printing device 30.

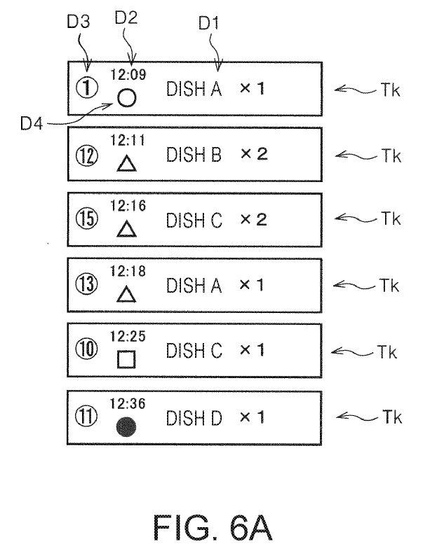

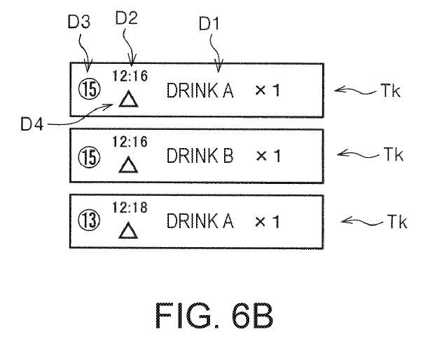

FIGS. 6A and FIG. 6B illustrate order slips Tk printed by the printing device 30. FIG. 6A illustrates an order slip Tk printed by the first printing device 30A and is an order slip Tk printed for a cook of the kitchen staff. FIG. 6B illustrates an order slip Tk printed by the second printing device 30B and is an order slip Tk printed for the kitchen staff in charge of drinks. That is, as an example, the first printing device 30A is arranged near the cook, and the second printing device 30B is arranged near the person in charge of drinks.

As described above, the order reception process section 12 of the order reception server 10 classifies the order data based on predetermined settings and generates the print data. The process data transmission section 13 of the order reception server 10 transmits the print data to each of the plurality of printing devices 30.

The order slip Tk is cut for each order menu by a cutting function provided in the printing device 30. The order slips Tk are arranged by the kitchen staff or the serving staff on a worktable (not illustrated) in the order of order reception as illustrated in the figure. When an ordered item is completed, the kitchen staff picks up the corresponding order slip Tk and hands it to the serving staff together with the ordered item.

The order slip Tk includes order content D1 indicating the name and quantity of the ordered item, an order time D2, a table number D3, and a first symbol D4.

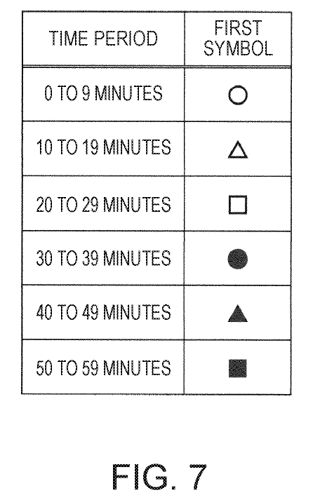

The first symbol D4 is a symbol set to be different for each time period as illustrated in FIG. 7. For example, a white circle is set for orders from 12:00 to 12:09 and a white triangle is set for orders from 12:10 to 12:19. It should be noted that although different symbols are set for every 10 minutes in the example of FIG. 7, the symbols may be divided by a time shorter than 10 minutes or may be divided by a time longer than 10 minutes. The symbols set in the respective time periods are also examples, and various other symbols can be adopted. The first symbol D4 to be set for each time period is stored as setting data in the storage 10g of the order reception server 10.

It should be noted that, for example, the first symbol D4 is the same at 12:05 and 13:05, but since it rarely takes one hour or more to provide the ordered item, as described above a plurality of order slips Tk having significantly different times are rarely mixed.

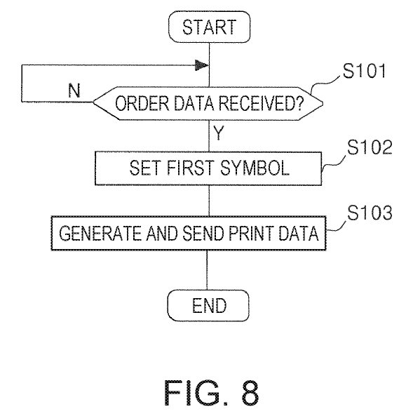

FIG. 8 illustrates the process flow of the order reception process section 12 and, when the order reception process section 12 receives order data (YES in step S101), it sets the first symbol D4 according to the order time (step S102), generates the print data, and sends the print data via the process data transmission section 13 (step S103).

As described above, the order reception process section 12 includes the content of the order and a symbol, that is, the first symbol D4, which varies depending on the time related to the order, in the print data to be sent to the printing device 30. This allows the store staff to visually recognize the first symbol D4, which varies depending on the time related to the order, in addition to the content of the order. For example, in a case where only the order content and the order time are printed on the order slip Tk, it may be difficult for the store staff to visually grasp the time, but according to the present embodiment, the store staff can easily visually grasp the order time by the first symbol D4. This enables the store staff to perform appropriate order processes, such as prioritizing the process of an order whose provision is delayed.

It should be noted that since the order reception process section 12 includes the order time in the print data, the store staff can accurately grasp the order time as necessary.

It should be noted that in the above embodiment, the first symbol D4 printed by the first printing device 30A, which is arranged near the cook, is the same as the first symbol D4 printed by the second printing device 30B, which is arranged near the person in charge of drinks. For example, FIG. 6A illustrates order slips Tk printed by the first printing device 30A, FIG. 6B illustrates order slips Tk printed by the second printing device 30B, and the first symbol D4 corresponding to the time period described with reference to FIG. 7 is attached regardless of the content of the order.

It should be noted that the different first symbols D4 may be printed in different colors. That is, the order reception process section 12 may generate the print data so that the printing device 30 outputs different first symbols D4 in different colors. In this way, the store staff can more easily visually grasp the time.

In this embodiment, the output unit for visually outputting the content of the order according to the process data of the order reception server 10 is constituted by the printing device 30 for printing the order content D1 and the first symbol D4 on the medium, so that the store staff can easily visually recognize the order content D1 and the first symbol D4.

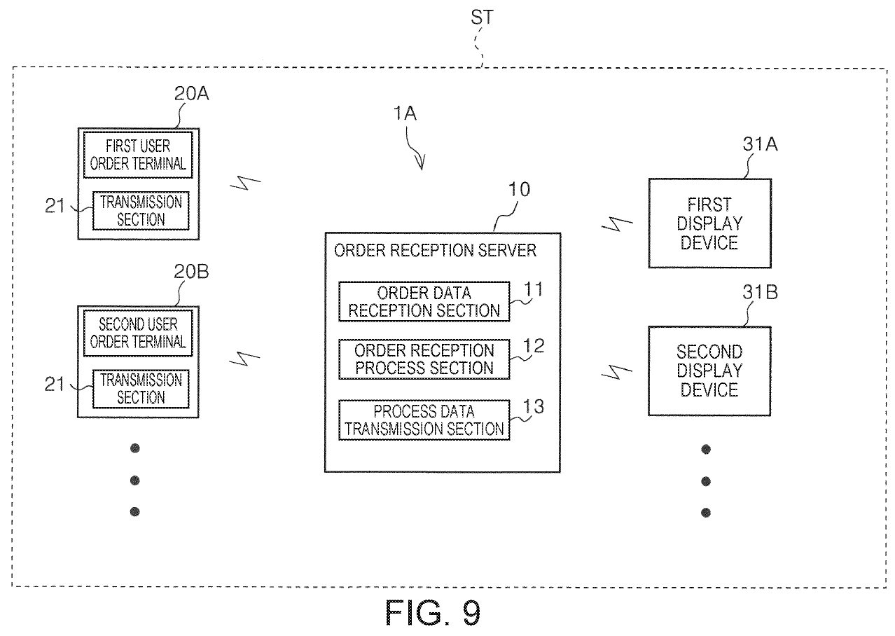

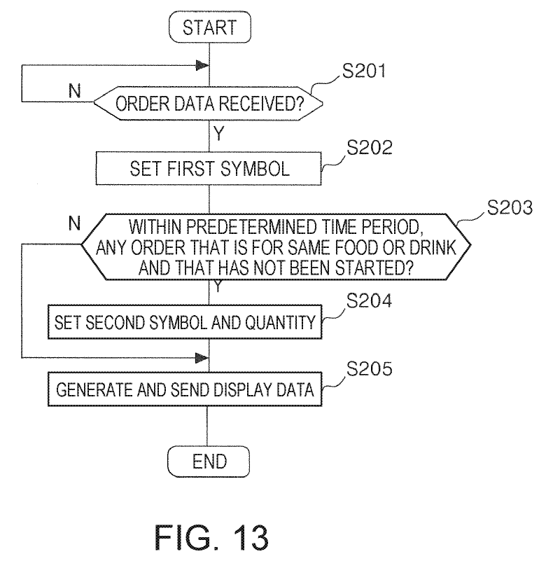

Next, another embodiment will be described with reference to FIGS. 9 - FIG. 13.

The order reception management system 1A illustrated in FIG. 9 is different from the above-described order reception management system 1 in that a display device 31 is adopted in place of the printing device 30 as an output unit for visually outputting the content of the order. Specifically, the order reception management system 1A includes a first display device 31A and a second display device 31B. Hereinafter, the first display device 31A and the second display device 31B are collectively referred to as a display device 31 when they are not distinguished from each other. It should be noted that although two display devices 31 are illustrated in FIG. 9, the number of display devices 31 is not limited to this.

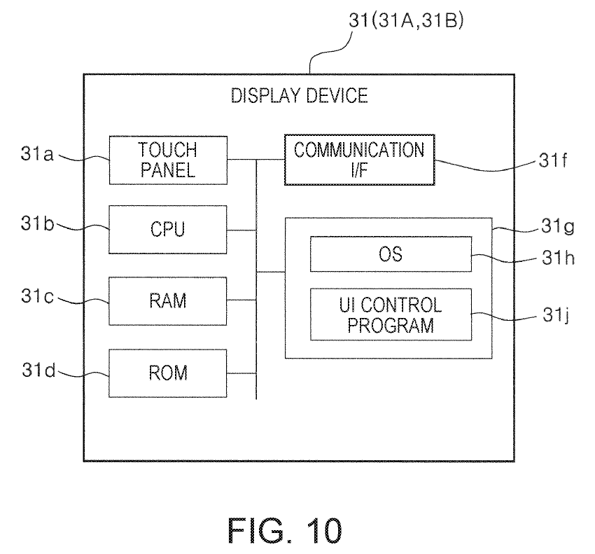

Hereinafter, the configuration of the display device 31 will be described with reference to FIG. 10.

The display device 31 includes a touch panel 31a, CPU 31b, RAM 31c, ROM 31d, a communication I/F 31f, and a storage 31g.

The storage 31g is configured by an information storage device such as a flash memory. The storage 31g stores various data and various programs such as an operating system 31h and a UI control program 31j.

The UI control program 31j is a program for controlling the display of the touch panel 31a, in particular, the display of the UI and, unless otherwise specified, various processes performed by the display device 31 described below are realized by executing the UI control program 31j.

The CPU 31b loads various programs and the like stored in the ROM 31d or the storage 31g into the RAM 31c, which is a volatile memory, and executes the programs.

The touch panel 31a displays various types of information and receives various operations by the store staff.

The communication I/F 31f includes a communication interface for connecting the display device 31 to the order reception server 10.

It should be noted that since the display device 31 is touched by a store staff that provides food and drink, it is more preferable to use a non-contact type touch panel 31a.

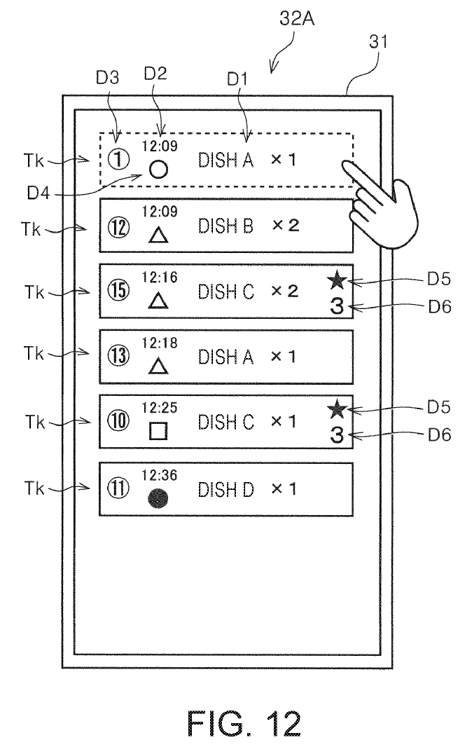

The display device 31 displays the UI 32A illustrated in FIG. 12. In the UI 32A of the display device 31, the order slips Tk described with reference to FIGS. 6A and FIG. 6B are displayed on the screen instead of being printed out. The UI 32A can be operated by the store staff, and the UI control program 31j realizes the following functions according to operations on the UI 32A by the store staff.

For example, when the kitchen staff touches an order slip Tk, the frame line changes from a solid line to a broken line as illustrated by the uppermost order slip Tk as an example. This change indicates that the kitchen staff has started to prepare the ordered item. It should be noted that when the order slip Tk is touched again, the frame line returns from the broken line to the solid line, and the start of preparation of the ordered item can be canceled.

It should be noted that instead of changing the frame line in this manner, the frame line or the color of the displayed characters may be changed between the state before starting preparation and the state after starting preparation. By such a change in the display, the kitchen staff can visually recognize orders that have not been started and orders that have been started.

When the ordered item is completed, the kitchen staff swipes the corresponding order slip Tk in the horizontal direction. By this, the corresponding order slip Tk is deleted from the UI 32A. It should be noted that a confirmation button for confirming a past order slip Tk that was deleted from the UI 32A may be arranged on the UI 32A, and the screen may be shifted to a UI (not illustrated) for confirming past order slips Tk that were deleted. Such a UI can be realized by referring to the received order data 10m, which will be described later with reference to FIG. 11.

A display device 31 may be provided for the serving staff. In this case, when the kitchen staff swipes the order slip Tk in the horizontal direction and the order slip Tk is deleted from the UI 32A for the kitchen staff, the corresponding order slip Tk may be displayed on the UI (not illustrated) for the serving staff. This allows the serving staff to easily grasp that an ordered item was completed. The serving staff may be able to erase an order slip Tk by swiping the order slip Tk related to the served order in the horizontal direction, similarly to the kitchen staff member.

Next, FIG. 11 illustrates an example of information included in the received order data 10m. The contents of the received order data 10m illustrated in FIG. 11 are different from the contents of the received order data 10m illustrated in FIG. 5 in that the received order data reservation illustrated in FIG. 11 includes the items of cooking started, cooking completed, and served.

In these items of cooking started, cooking completed, and the served, "0" is set as a flag in advance when the order data is received. "0" is a flag indicating that a process is not completed. When the kitchen staff taps the order slip Tk for which cooking has started, the frame line changes to the broken line as described with reference to FIG. 12 and, at this time, the display device 31 transmits information indicating that cooking has been started to the order reception server 10. In response to this, the order reception server 10 sets the flag indicating the cooking started to "1". Here, "1" is a flag indicating that cooking has started.

As described with reference to FIG. 12, when the kitchen staff who finished cooking swipes that order slip Tk in the horizontal direction, the corresponding order slip Tk is deleted from the UI and, at this time, the display device 31 notifies the order reception server 10 of information indicating that cooking was completed. In response to this, the order reception server 10 sets the flag indicating cooking completion to "1". Here, "1" is a flag indicating that cooking was completed.

In a case where the display device 31 is provided for the serving staff, when the serving staff finishes serving and swipes the corresponding order slip Tk in the horizontal direction, the corresponding order slip Tk is deleted from the UI and, at this time, the display device 31 transmits, to the order reception server 10m, information indicating that serving was completed. In response to this, the order reception server 10 sets the flag that indicates serving to "1". Here, "1" is a flag indicating that serving was completed.

It should be noted that in addition to the items of cooking started, cooking completed, and served, an item of “payment" may be provided. When the customer finishes payment, the flag may be changed from "0" to "1".

In the present embodiment, as in the embodiment described with reference to FIGS. 1 - 8, when the order reception process section 12 of the order reception server 10 receives order data and updates the received order data 10m, it generates display data, which is an example of process data, based on the order data. The process data transmission section 13 of the order reception server 10 sends the display data to the display device 31. The display device 31 displays the order slips Tk as illustrated in FIG. 12.

That is, in the present embodiment, the order reception process section 12 includes the content of the order and the symbol that varies depending on the time related to the order, that is, the first symbol D4, in the display data to be sent to the display device 31. This allows the store staff to visually recognize the first symbol D4, which varies depending on the time related to the order, in addition to the content of the order. As a result, the store staff can easily visually grasp the order time by the first symbol D4, and can perform appropriate order process such as prioritizing processes for an order that is delayed in being served.

In the present embodiment, the order reception process section 12 includes the order time in the display data, and thus the store staff can accurately grasp the order time as necessary.

In the present embodiment, different first symbols D4 may be displayed in different colors. That is, the order reception process section 12 may generate display data so that the display device 31 displays the different first symbols D4 in different colors. In this way, the store staff can more easily visually grasp the time.

Next, in the present embodiment, a second symbol D5, which is different from the first symbol D4, is displayed on the order slip Tk. The second symbol D5 is a symbol that is assigned when there are orders for the same food or drink and, in the example illustrated in FIG. 12, orders for "dish C" were placed at a table number 15 and a table number 10. However, the second symbol D5 is attached when the same food or drink is ordered within a predetermined time. For example, when an order for "dish C" is placed at table number 10 within 15 minutes after an order for "dish C" is placed at table number 15, the second symbol D5 is added to the order slips Tk for table number 15 and table number 10.

In the present embodiment, the second symbol D5 is accompanied by a quantity D6 indicating the total quantity of the same food or drink.

FIG. 13 illustrates the process flow by the order reception process section 12 and, when the order reception process section 12 receives order data (Yes in step S201), the order reception process section 12 sets the first symbol D4 (step S202). Next, the order reception process section 12 determines whether within a predetermined time period there is an order that is for the same food or drink and that has not been started (step S203). Here, the "food and drink has not been started" means food and drink for which the flag of "cooking started" described with reference to FIG. 11 is "0". The "predetermined time" is stored as setting data in the storage 10g of the order reception server 10.

When within the predetermined time there is an order that is for the same food or drink and that has not been started (Yes in step S203), the order reception process section 12 sets the second symbol D5 and the quantity D6 (step S204) and transmits the display data via the process data transmission section 13 (step S205). In response to this, the display device 31 displays the order slip Tk.

As described above, when the order reception process section 12 receives the order data related to the first order and then after that, within a predetermined time, receives the order data related to the second order that includes the same food and drink as the food and drink included in the first order, the order reception process section 12 includes, in the process data, the second symbol D5, which is different from the first symbol D4 and which indicates that the same food and drink has been ordered.

By this, the kitchen staff can visually recognize the second symbol D5 indicating that the same food or drink has been ordered in addition to the content of the order and the first symbol D4, and can therefore collectively process the same food or drink, thereby improving the efficiency of the order process.

In addition, since the order reception process section 12 includes the number of the same food or drink in the process data, the kitchen staff can grasp the total number together with the second symbol D5 indicating that the same food or drink has been ordered, and the efficiency of the ordering process can be further improved.

When the two symbols of the first symbol D4 and the second symbol D5 are arranged at positions close to each other, there is a possibility that the kitchen staff erroneously recognizes the two symbols as the first symbol D4 together. However, in the present embodiment, the order reception process section 12 arranges the order content D1 between the first symbol D4 and the second symbol D5 so that the occurrence of the above problem can be suppressed.

It should be noted that when the same food or drink is ordered, the order reception process section 12 generates display data so that the second symbol D5 and the quantity D6 are displayed not only on the order slip Dk of the order that was placed later but also on the order slip Dk of the order that was placed earlier. This allows the kitchen staff to easily visually recognize an order for the same food or drink.

It should be noted that the predetermined time (step S203 in FIG. 13) may be set for each food or drink. Hereinafter, the predetermined time is referred to as a predetermined time Tn.

For example, even when orders for the same food or drink are generated, as a result of collectively processing the orders, processing the earliest order may be delayed due to the time required for the processes, which may be a problem. Such a problem is likely to occur in the case of food and drink that requires time to process the order. For example, in the case of dishes that require time for cooking, serving of the first order may be delayed if the dishes are processed together. In this case, it is preferable to set the predetermined time Tn for a dish that requires a long time to cook to be shorter than the predetermined time Tn for a drink, a dish, or the like that does not require a long time to serve.

It should be noted that if the presence or absence of cooking started described with reference to FIG. 11 is not managed, when the same food or drink is ordered, the food or drink of the previous order may have already been completed, and it may be inappropriate to add the second symbol D5. In order to avoid such a problem, it is desirable to set the predetermined time Tn for a dish, a drink, or the like that does not require a long time to be served to be shorter than the predetermined time Tn for a dish that requires a long time to be cooked. In this case, the predetermined time Tn may be set to be equal to the time required for cooking.

The first symbol D4 relating to a subsequent order where the same food or drink is ordered may be the same as the first symbol D4 relating to a previous order. That is, the order reception process section 12 may generate the display data so that the first symbol D4 related to the second order is the same as the first symbol D4 related to the first order. According to such a process, in the example illustrated in FIG. 12, the first symbol D4 for table number 10, which is the subsequent order, is not a square but a triangle similarly to the first symbol D4 for table number 15.

That is, in a case where plural order processes are collectively performed, there is a concern that the person who ordered may be dissatisfied if the process of the first order, which is the earliest order, is delayed. However, by setting the first symbol D4 related to the later order to be the same as the first symbol D4 related to the earlier order, it is possible to suppress the delay of the process of the first order.

It should be noted that in this embodiment, the store staff can easily visually recognize the order content D1 and the first symbol D4 because the display device 31 for displaying the order content D1 and the first symbol D4 on the screen constitutes the output unit for visually outputting the content of the order in accordance with the process data of the order reception server 10. In the present embodiment, the second symbol D5 and the quantity D6 can also be easily visually recognized.

In particular, since the content of the order slips Tk can be continually updated to the most recent state, the second symbol D5 and the quantity D6 can be updated to the most recent state.

The embodiments described above can be modified as follows.
(1) The terminal that receives the order of the customer and that transmits the order data is not limited to the user order terminal 20 and may be a portable terminal carried by the serving staff, a register terminal that receives payment, or the like. The terminal that receives the order from the customer and that transmits the order data may be a portable information terminal owned by the user, instead of a terminal owned by the store ST.
(2) The order reception server 10 may be installed outside the store ST. For example, the order reception server 10 may be connected to a local area network of the store ST via the Internet.
(3) The order reception management system 1 may be configured to include the order reception server 10 and an output unit that visually outputs the content of the order according to the process data of the order reception server 10. In addition to such a configuration, the order reception management system 1 may further include a transmission section that generates order data according to an order of a customer and that transmits the order data to the order reception server 10 as in the above-described embodiment.

The transmission section may be regarded as the user order terminal 20 described in the above embodiment or may be regarded as the transmission section 21 included in the user order terminal 20.

(4) The order reception server 10 and the output unit for visually outputting the content of the order according to the process data of the order reception server 10 are not limited the aspect of being installed at the positions separated from each other but may be arranged at one place. For example, the display section 10a (see FIG. 2) included in the order reception server 10 may be the output unit.

The order reception server 10 itself may be provided with a transmission section that generates order data in accordance with an order of a customer and that transmits the order data to the order reception server 10. For example, the store staff may be able to input the customer's order to the order reception server 10 using the operation section 10e (see FIG. 2) included in the order reception server 10.

(5) The order time D2 printed or displayed on the order slip Tk is an example of the time related to the order, and is not necessarily limited to the time when the "confirm order" button 23c (see FIG. 4B) is tapped. For example, the order time D2 may be the time at which the order reception server 10 receives the order data.

In the case of an order in which the time of completion of the ordered item is specified in delivery or take-out, the specified time may be further printed or displayed in addition to the order time D2. In this case, it is preferable to adjust the timing of printing or displaying the order slip Tk. For example, it is preferable to print or display the order slip Tk at a predetermined time before the designated time. The predetermined time is preferably a time having a certain margin with respect to a time required for cooking. In this case, the reference time of the first symbol D4, the second symbol D5, and the quantity D6 may be the time when the order slip Tk is printed or displayed.

(6) In the above embodiment, the second symbol D5 is set when orders with the cooking started flag set to "1" are excluded, that is, when there is an order within a predetermined time that is for the same food or drink and that has not been started (Yes in step S203 and step S204 in FIG. 13), but a cooking completed flag or a serving flag may be adopted instead of a cooking started flag. That is, the settings for the second symbol D5 may be such that orders for which the cooking completed flag is "1" and orders for which the served flag is "1" are excluded.

(7) In the above embodiment, the second symbol D5 is attached when an order for the same food or drink is placed within a predetermined time, but it may be attached when an order for the same food or drink is placed in a time period for setting the first symbol D4 (see FIG. 7). For example, the second symbol D5 may be set when the same food or drink is ordered between 12:00 and 12:09.

(8) In the above embodiments, the order reception server 10 changes the serving flag (see FIG. 11) from "0" to "1" based on the information transmitted from the display device 31 provided for the serving staff. Here, the display device 31 provided for the serving staff may be a portable terminal or a terminal fixed on a desk.

Instead of the display device 31 provided for the serving staff, the information indicating that the food or drink has been served may be transmitted from the user order terminal 20 to the order reception server 10. In this case, for example, when the serving staff provides food and drink, the serving staff operates the user order terminal 20 to transmit, to the order reception server 10, information indicating that the food and drink has been served. In this case, the user order terminal 20 may be a portable information terminal owned by the customer.

(9) In the above embodiments, the second symbol D5 and the quantity D6 are displayed in the embodiment using the display device 31, but the present disclosure may be applied to the embodiment described with reference to FIGS. 1 - 8, that is, the embodiment using the printing device 30 as the output unit. That is, the second symbol D5 and the quantity D6 may be printed and displayed on the order slips Tk printed by the printing device 30.

In this case, an order for which any of the cooking started, cooking completed, of serving flags described with reference to FIG. 11 is "1" may be excluded from the target when the setting of the second symbol D5 or the quantity D6 is determined.

(10) In the above embodiments, the progress of the order process is managed by the flags "0" and "1" (see FIG. 11), but for example, "cooking not started", "cooking started", "cooking completed", “served", and the like may be provided as data holding areas, and the progress of the order process may be managed by moving the order data to each data holding area according to the progress of the order process.

(11) The system control program 10j (see FIG. 2), the UI control program 20j (see FIG. 3), and the UI control program 31j (see FIG. 10) may be manufactured as individual programs, and in this case, may be provided for free or for a fee. Specific examples of the aspect of providing the program include an aspect of providing the program by writing the program in a computer-readable storage medium, an aspect of providing the program by downloading the program via an electric communication circuit such as the Internet, and the like. By operating a computer according to the program provided by these aspects, the computer can function as each device in the above embodiment.

Furthermore, the present disclosure is not limited to the embodiments and the modified examples described above, and various modifications are possible within the scope of the disclosure described in the claims, and it is needless to say that they are also included in the scope of the present disclosure.

What is claimed is:

1. An order reception management device comprising:
an order data reception section configured to receive order data including information related to an order of a customer;
an order reception process section configured to process the order data received by the order data reception section to generate process data; and
a process data transmission section that sends the process data to an output unit that visually outputs content of the order according to the process data, wherein
the order reception process section includes, in the process data, content of the order and a symbol that varies depending on a time related to the order.

2. The order reception management device according to claim 1, wherein
the order reception process section includes, in the process data, a time related to the order.

3. The order reception management device according to claim 1, wherein
the order reception process section generates the process data so that the output unit outputs the different symbols in different colors.

4. The order reception management device according to claim 1, wherein
the symbol is a first symbol and
when, within a predetermined time after order data related to a first order is received, order data is received related to a second order including a product or service that is the same as a product or service included in the first order, then the order reception process section includes, in the process data, a second symbol that is different from the first symbol and that indicates that the same product or service has been ordered.

5. The order reception management device according to claim 4, wherein
the order reception process section includes, in the process data, a number of products or services that are the same.

6. The order reception management device according to claim 4, wherein
the order reception process section generates the process data so as to arrange the content of the order between the first symbol and the second symbol.

7. The order reception management device according to claim 4, wherein
the predetermined time is set for each product or service.

8. The order reception management device according to claim 4, wherein
the order reception process section generates the process data so that the first symbol related to the second order is the same as the first symbol related to the first order.

9. An order reception management system comprising:
the order reception management device according to claim 1 and
the output unit.

10. The order reception management system according to claim 9, wherein
the output unit is constituted by a printing device for printing the content of the order and the symbol on a medium.

11. The order reception management system according to claim 9, wherein
the output unit is constituted by a display device for displaying the content of the order and the symbol on a screen.

12. An order reception management system comprising:
the order reception management device according to claim 5 and
the output unit, wherein
the output unit is constituted by a display device for displaying the content of the order and the symbol on a screen.

13. An order reception management system comprising:
the order reception management device according to claim 1;
a transmission section that generates the order data according to an order of a customer and transmits the order data to the order reception management device; and
the output unit.
